(19) United States
(12) Patent Application Publication
(10) Pub. No.: US 2014/0341523 A1
(43) Pub. Date: Nov. 20, 2014

(54) OVERHEAD CABLE TERMINATION ARRANGEMENT

(71) Applicants: Tyco Electronics Raychem BVBA, Kessel-Lo (BE); Tyco Electronics UK Ltd., Swindon Wiltshire (GB)

(72) Inventors: Alistair J. Waite, Pontypool Gwent (GB); Danny Ghislain Thijs, Zonhoven (BE)

(73) Assignee: Tyco Electronics Raychem BVBA, Kessel-Lo (BE)

(21) Appl. No.: 14/368,087

(22) PCT Filed: Dec. 6, 2012
(86) PCT No.: PCT/EP2012/074612

§ 371 Date: Jun. 23, 2014

Related U.S. Application Data
(60) Provisional application No. 61/579,396, filed on Dec. 22, 2011.
(60) Provisional application No. 61/701,321, filed on Sep. 14, 2012.

(51) Int. Cl. G02B 6/48

(52) U.S. Cl. CPC G02B 6/48
USPC 385/136

(57) ABSTRACT

A telecommunications apparatus (10, 210) includes a frame (20, 220) for mounting to a fiber optic cable trough (104, 106, 206). The frame (20, 220) includes a main body (22, 222) defining at least one opening (24, 26). The opening (24, 26) receives a connector module (60, 260). The frame (20, 220) includes a plurality of extensions (40, 240) extending transversely to the main body (22), wherein one or more extensions (40, 240) includes two parallel prongs (42) separated by a slot (44). Fasteners (34) mount the frame (20, 220) to slots (138) on a trough system element.

### TECHNICAL FIELD

This disclosure relates to methods and devices for use in the telecommunications industry. More specifically, this disclosure relates to methods and devices for use in managing and organizing telecommunications cables and cable termination components.

### BACKGROUND OF THE INVENTION

In the telecommunications industry, effective management and organization of cables and associate cable termination components is necessary in light of the massive cabling schematics involved in providing telecommunication services. Telecommunication facilities, such as data centers or central offices, for example, often have rows of equipment racks and/or equipment cabinets interconnected to cables routed overhead. The cabling schematics of such facilities involve dropping cables down from overhead troughs or ladders, for example, and terminating the cables to termination panels mounted on the racks or in the cabinets.

Space to accommodate the increasing demand for telecommunication services is limited. Improvements are needed in the methods and devices for managing and organizing the systems, cabling schematics, and components associated with providing telecommunication services.

### SUMMARY OF THE INVENTION

The present disclosure relates to an overhead cable management system including a cable termination device that mounts to an overhead cable pathway structure. The overhead cable pathway structure can include, for example, a U-shaped trough or a ladder-type structure. The overhead arrangement of the cable termination device allots more space on equipment racks or in equipment cabinets for telecommunication equipment.

One embodiment of a cable termination device mounts to overhead cable management system with a quick connection device to mount cable terminations to the overhead troughing or other components. The quick connection device mounts connectors, adapters, modules or other equipment to the troughing or other components.

A telecommunications apparatus includes a frame for mounting to a cable trough. The frame includes a main body defining at least one opening. The opening receives a connector module. The frame includes a plurality of extensions extending transversely to the main body, wherein parallel prongs are defined separated by a slot. Fasteners mount the prongs of the frame to the slots on a trough system element.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of one embodiment of a cable management system including a lateral cable trough and a cable exit trough;

FIG. 2 is a side view of the system of FIG. 1;

FIG. 3 is an exploded view of the system of FIG. 1;

FIG. 4 is a front view of a telecommunications system including multiple embodiments of a cable termination device mounted to a cable trough in accordance with the principles disclosed;

FIG. 5 is a bottom perspective view of a cable exit trough including a cable termination device;

FIG. 6 is a side view of the device of FIG. 5;

FIG. 7 is a further side view of the device of FIG. 5;

FIG. 8 is an exploded perspective view of the device of FIG. 5;

FIG. 9 is an exploded view of the cable termination device;

FIG. 9A shows a threaded fastener in greater detail;

FIG. 10 is an alternative embodiment of a cable termination device mounted to a cable exit trough;

FIG. 11 is an exploded perspective view of the alternative embodiment of the cable termination device mounted to a cable exit trough shown in FIG. 10;

FIG. 12 is a top perspective view of the cable termination device of FIG. 5 mounted to a different lateral trough element;

FIG. 13 is an exploded perspective view of the device of FIG. 12;

FIG. 14 is a perspective view of the cable termination device of FIG. 10, shown mounted to an end of a lateral trough;

FIG. 15 is an exploded perspective view of the device shown in FIG. 14.

### DETAILED DESCRIPTION

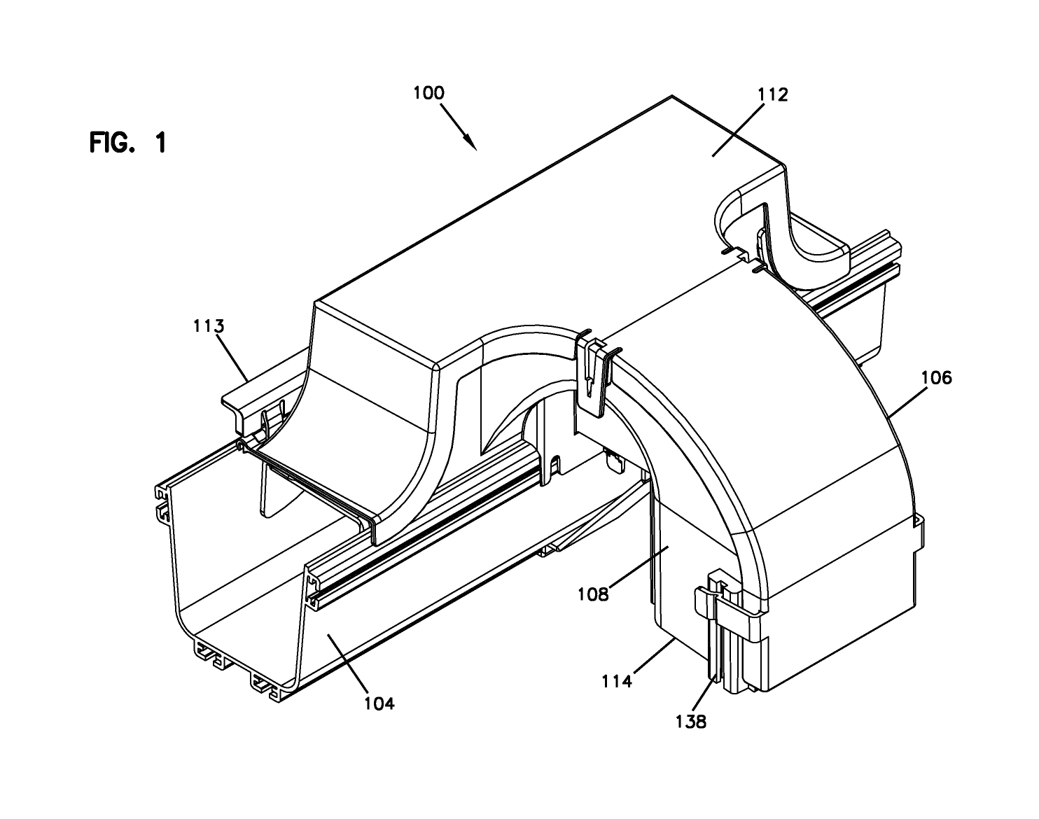

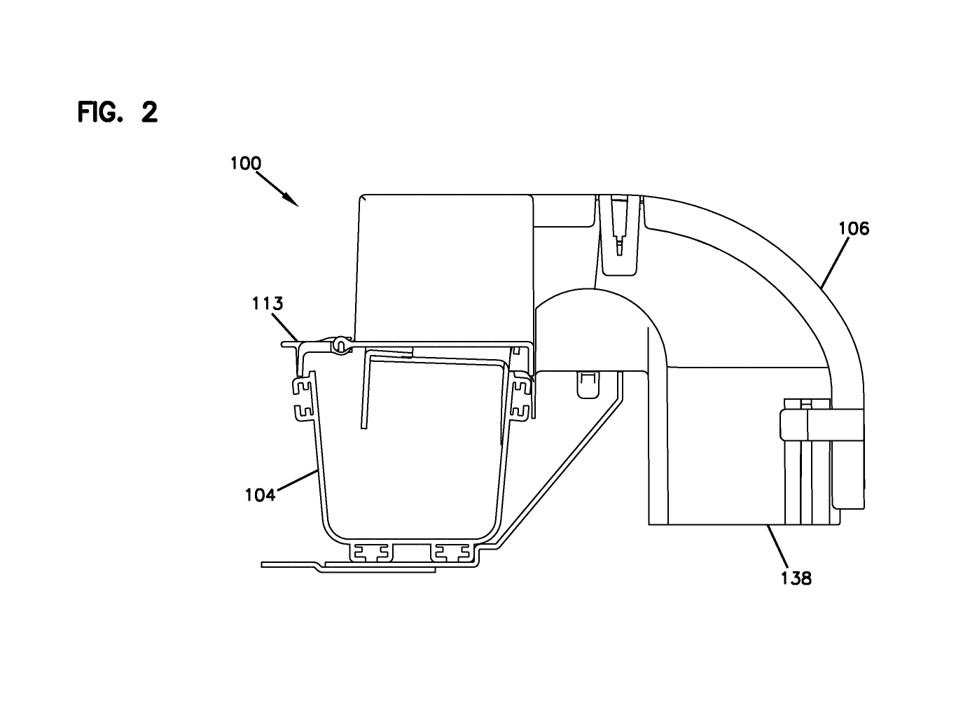

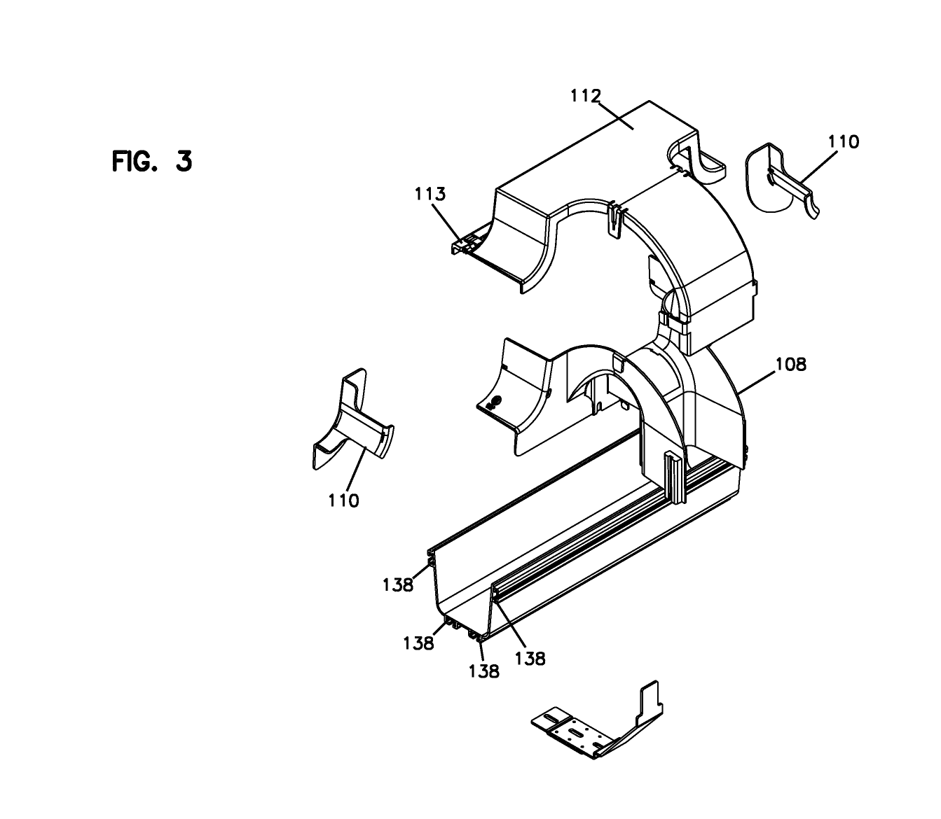

FIGS. 1-4 illustrates one embodiment of an overhead cable management system 100 which includes a lateral trough 104 and a cable exit trough 106. The overhead cable management system 100 is designed to manage and organize cables and related components to increase capacity in limited telecommunication facility space. The overhead cable management system 100 of the present disclosure includes a cable termination device or apparatus 10 that mounts to an overhead cable pathway structure of the cable management system 100.

Cable exit trough 106 includes a main body 108, flanges 110, and a cover 112. A pivoting cover portion 113 allows for access to cable trough 104. Downspout portion 114 includes slots 138. Lateral trough 104 also includes slots 138. More details of cable exit troughs are shown in U.S. Pat. No. 6,535,683, the disclosure of which is incorporated by reference. Cable exit troughs 106 allow cables to exit cable trough or lateral trough 104.

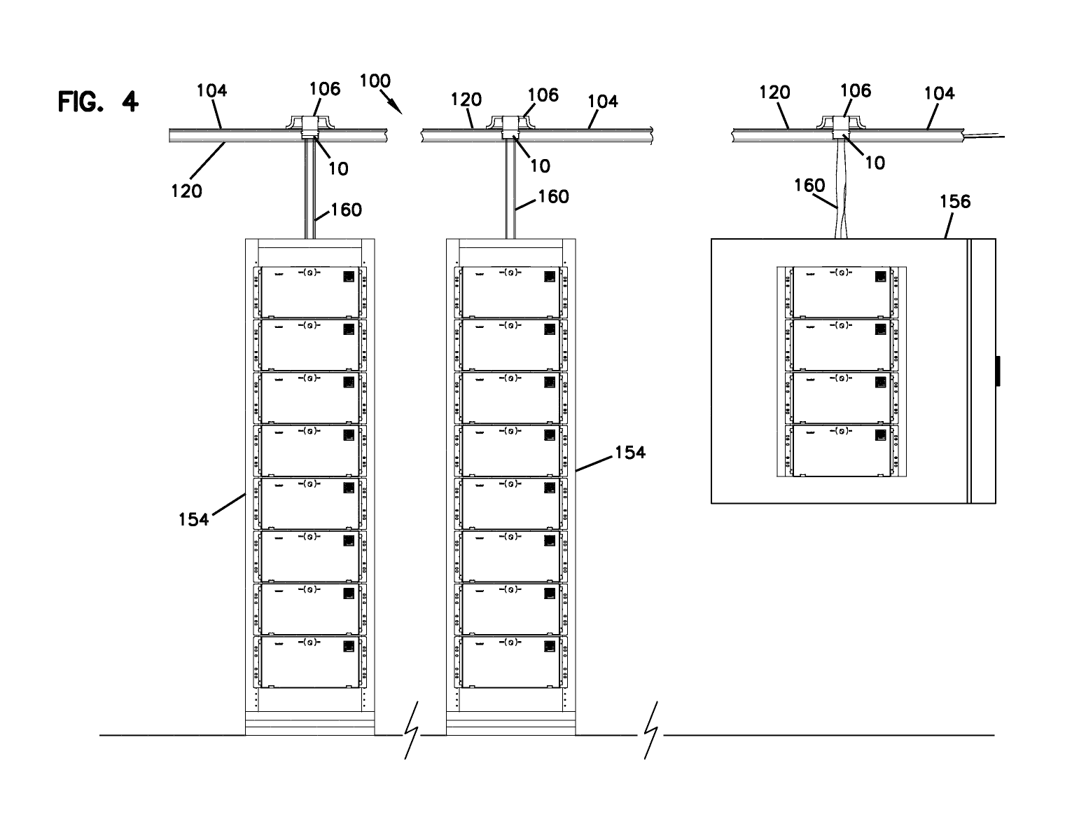

Referring to FIG. 4, in telecommunication facilities, such as data centers or central offices, for example, overhead cable pathway structures 120 are hung above racks 154, cabinets 156, and/or other equipment enclosures or framework. The overhead cable pathway structures 120 carry cables that interconnect to equipment mounted to on the racks, for example. For the purposes of simplification, the remaining description refers to the structure in which the equipment mounts as a “rack”; however it is to be understood that the present disclosure applies similarly to the other equipment structures (e.g., cabinets, and other enclosures or framework). The “overhead” cable pathway structures are typically run “overhead”, as racks commonly have a height equivalent or greater than the height of a technician. It is to be understood that “overhead” is not intended to be limiting to the height of the technician, but rather means that the cable pathway structures are located a distance from the floor, typically overhead, the more commonly above the structures to which the equipment is mounted (e.g. the rack or cabinet). In the illustrated embodiment FIG. 4, the overhead cable pathway structure includes a U-shaped channel or trough 104. In other embodiments, the overhead cable pathway structure can be a ladder-type structure. Other types of structures that carry cables overhead to and from racks or cabinets can be used in accordance with the principals disclosed.

In utilizing the space above equipment racks for the run of cables, it can be understood that the cable pathway structure provides a generally horizontal run for the cables. That is, the cable pathway structures are constructed such that the cables run more horizontally, rather than vertically, when carried by the cable pathway structure.

In conventional arrangements, cables carried by the overhead cable pathway structures are pulled down from the overhead structure and terminated to a termination panel mounted on the equipment racks. Termination panels are panels to which overhead cables are terminated and generally include a number of adapters or connectors. Jumper cables or patch cords are used to provide interconnections between the termination panel and the equipment mounted on the rack. The racks in conventional facility arrangements hold both the equipment and the termination panel to which the cables terminate, the termination panel occupying at least one of the limited number of unit spaces of the rack.

Referring still to FIG. 4, the overhead cable management system 100 of the present disclosure provides improvements upon spatial utilization of racks and facilities. That is, the overhead cable management system increases service capacity of a facility by providing cable terminations at a location other than the rack. Cable terminations are instead provided in unoccupied space above the racks at apparatus 10, with cables 160 extending downwardly from terminations associated with apparatus 10. Valuable rack space can thereby be allocated for more equipment, as opposed to being constrained by the requirement of a termination panel on racks 154 or in cabinets 156.

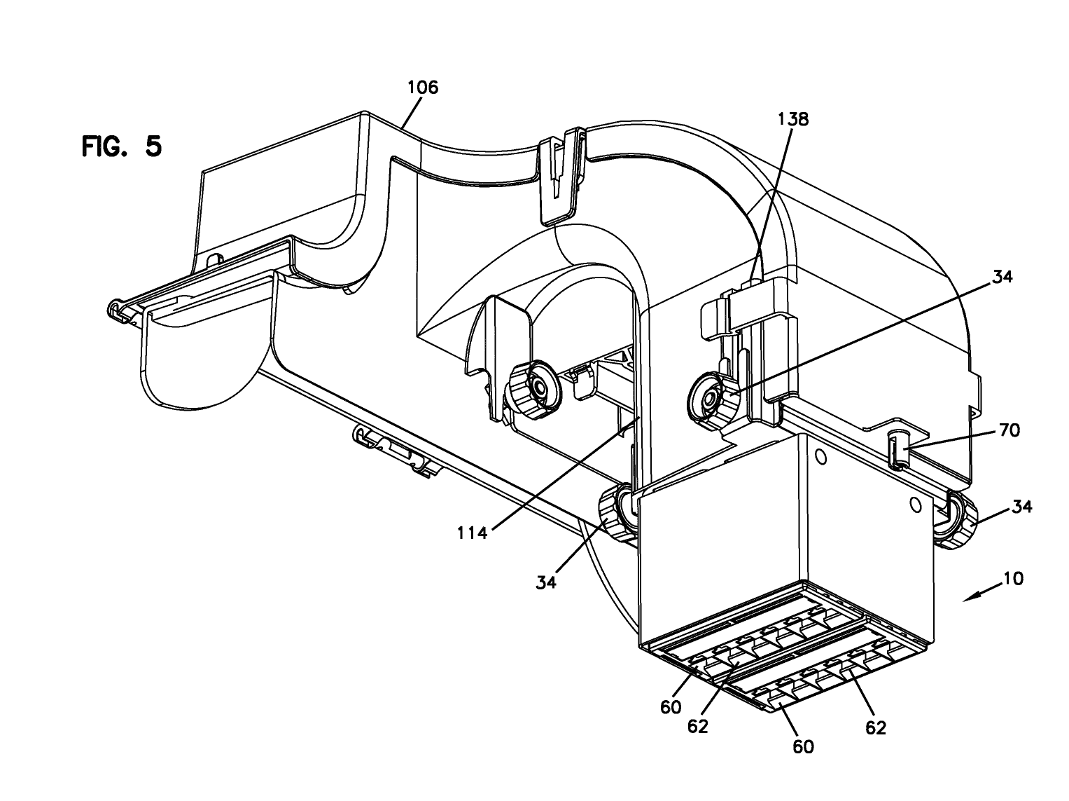

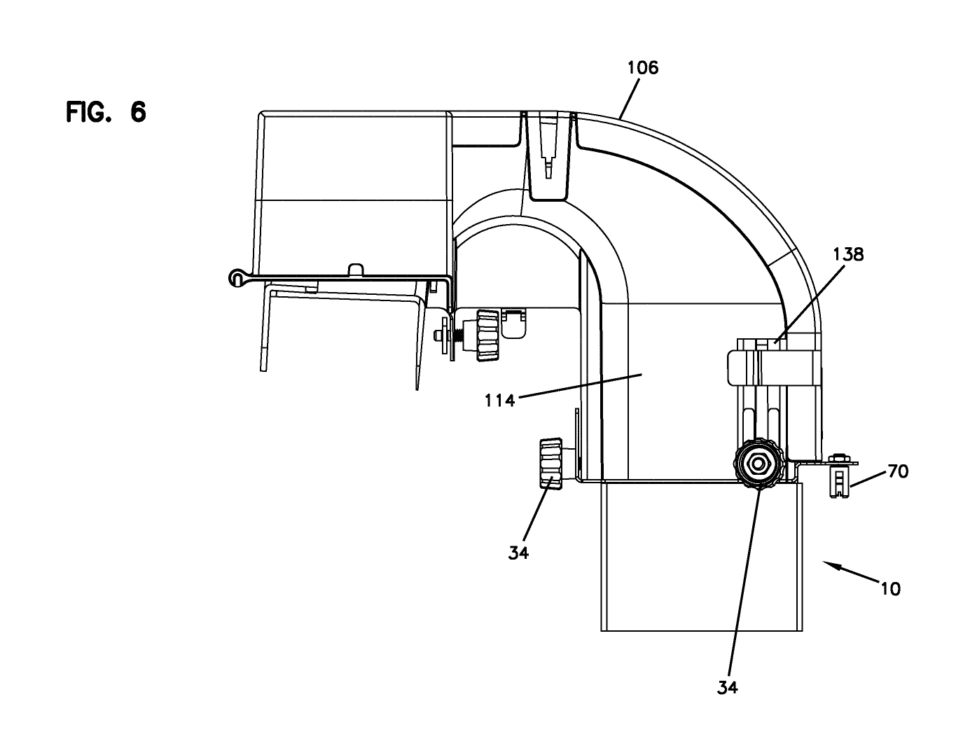

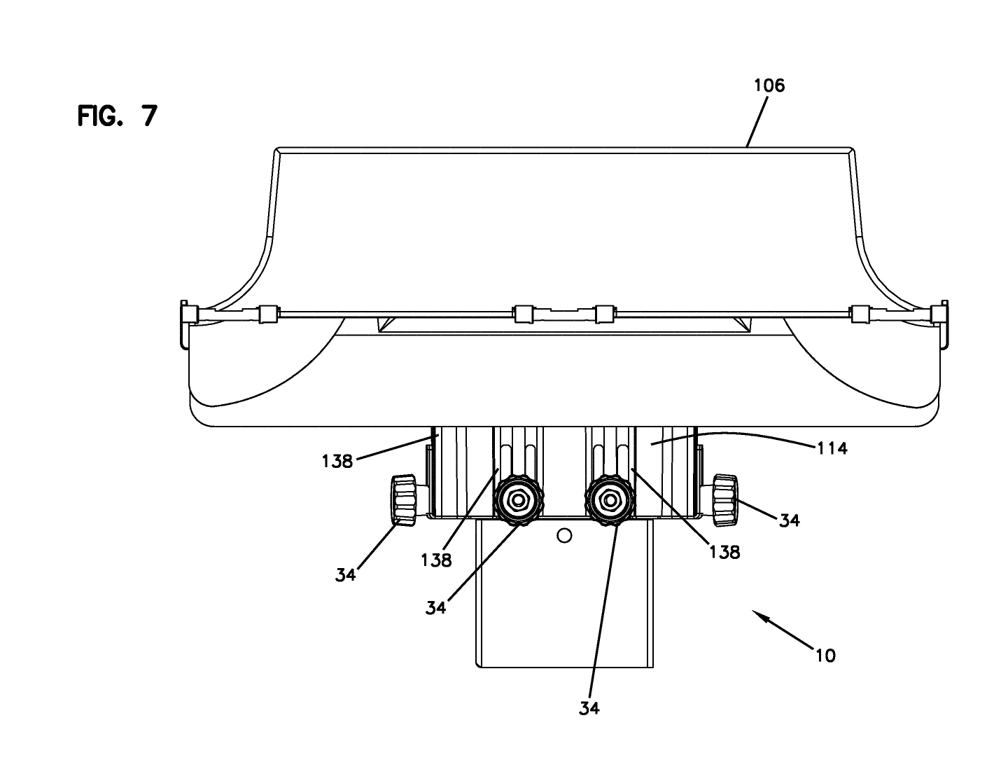

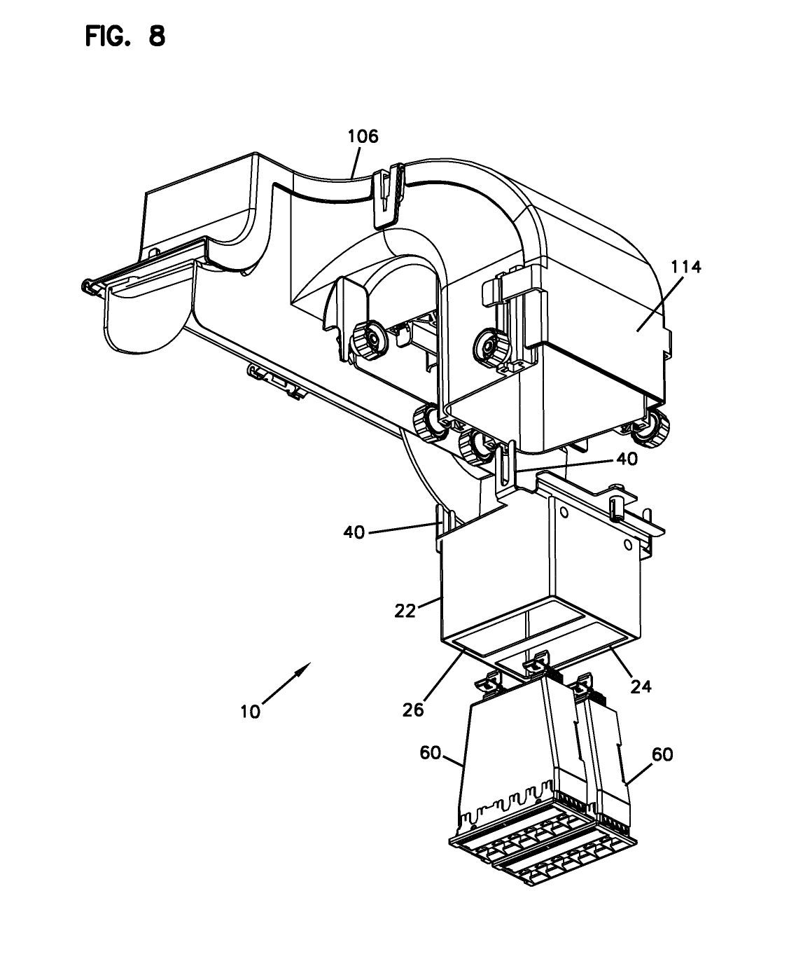

Referring to FIGS. 5-9 and 9A, the cable termination apparatus 10 includes a frame 20 including a main body 22 defining at least one opening 24. In the illustrated embodiment, main body 22 includes a second opening 26. Each opening 24, 26 receives a telecommunications connection module 60. Each connection module 60 includes one or more connection locations 62 on the front and the rear for connecting to cables. The front and rear connections can be copper, fiber, hybrid, or other. The connections can be the same or different, such as MPO on the rear, and single fiber on the front, or IDCs on the rear and RJ-45s on the front, in much the same way as rack mounted patch panels or modules. The modules/connections can be fiber adapter holders or RJ jack holders, for example. The modules 60 snap mount to frame 20.

Frame 20 of cable termination apparatus 10 includes extensions 40 which each include a pair of prongs 42 with a slot 44 defined there between. Threaded fasteners 34 thread into winged retaining pieces 36. The winged retaining pieces 36 are sized to fit within a slot 138 of exit trough 106 so as to mount prongs 42 of extensions 40 to exit trough 106. Prongs 42 mount outside of slots 138 in alignment with slots 38.

Each module 60 includes connection locations 62 on a front 64 and a back 66. A depth dimension D is created by module 60 for housing internal components and cabling. Main body 22 of frame 20 includes side walls 28 which define an interior for receiving module 60. A framework 32 mounts to side walls 28, and defines the prongs 42. Frame 20 includes a grounding lug 70 in order to provide a grounding location if desired. Referring back to FIG. 4, the overhead cable management system 100 includes cabling in the lateral troughs 104 extending into exit troughs 106 to modules 60 in the cable termination apparatus 10. Cables 160 mounted to the front 64 of modules 60 extend downward to racks 154 or cabinets 156. Cables 160 can be copper, fiber, hybrid, or other. Similarly, the cables in the lateral trough 104 extending to modules 60 can be copper, fiber, hybrid or other.

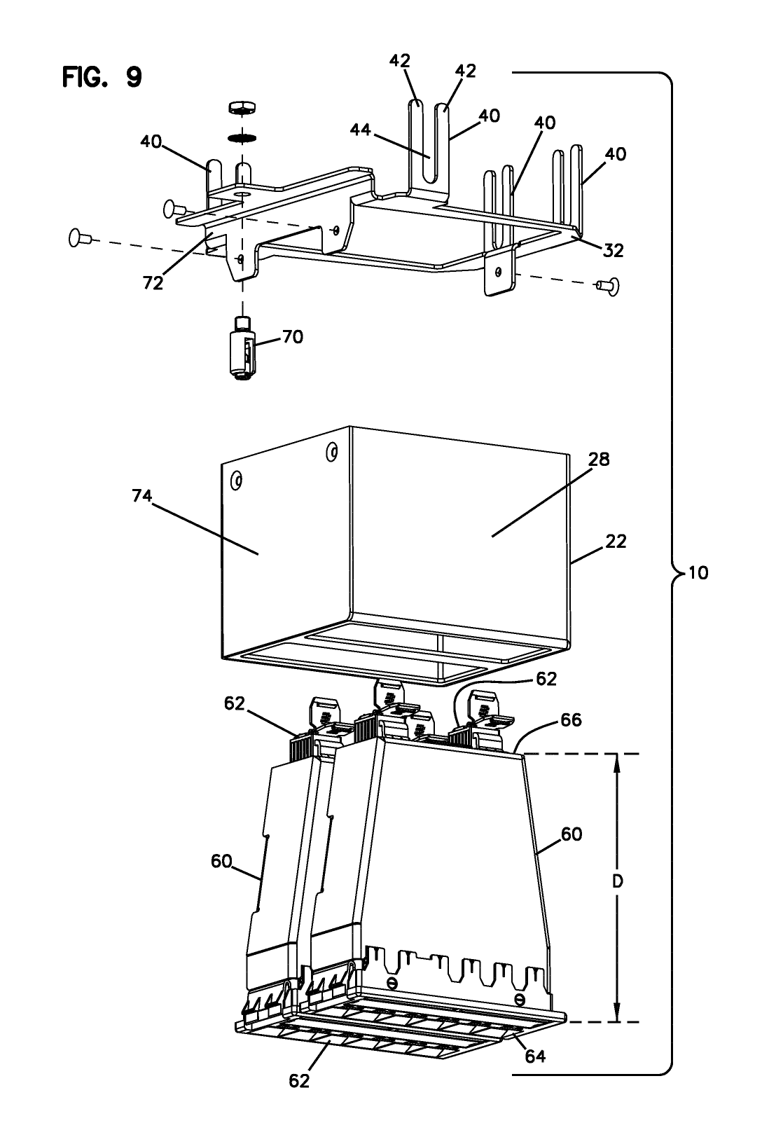

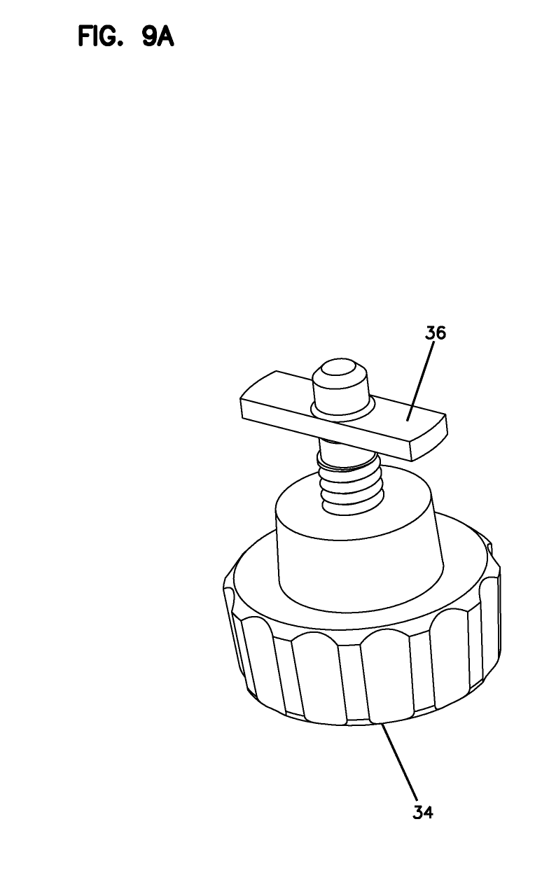

Referring back to FIG. 9, apparatus 10 is shown in exploded view. Frame 20 includes a first frame portion 72 and a second frame portion 74 fastened together which cooperate to define main body 22.

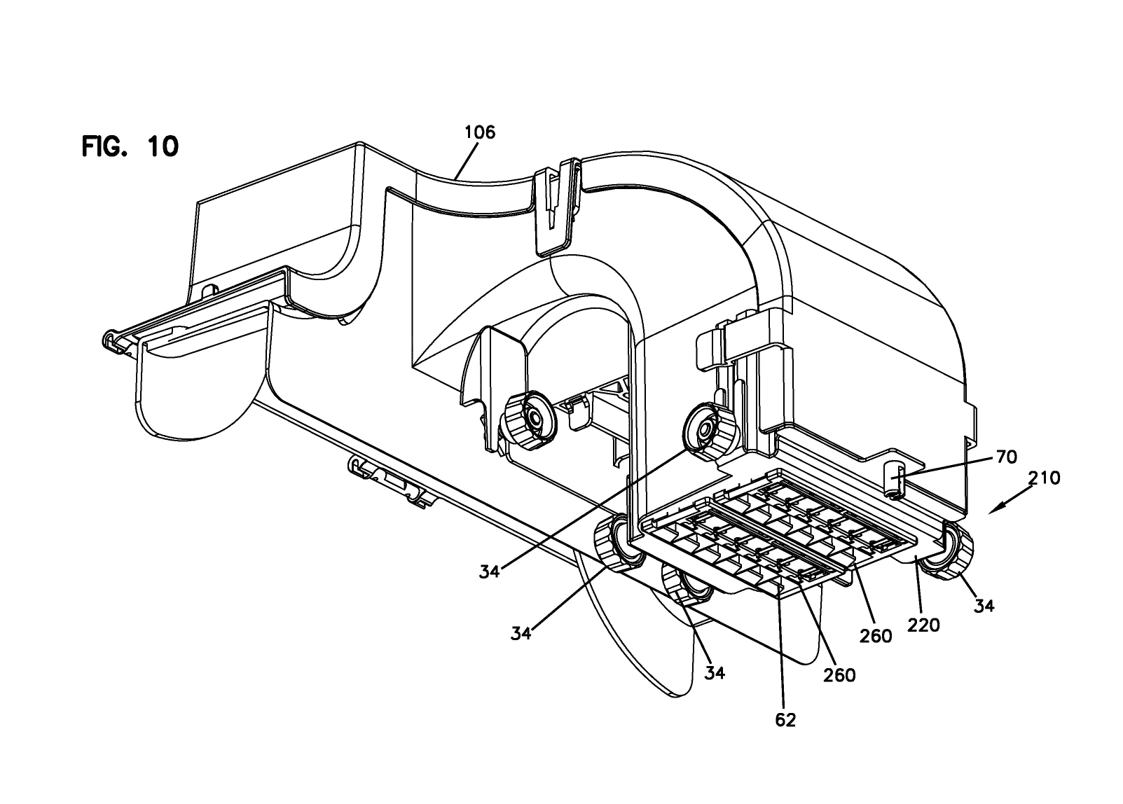

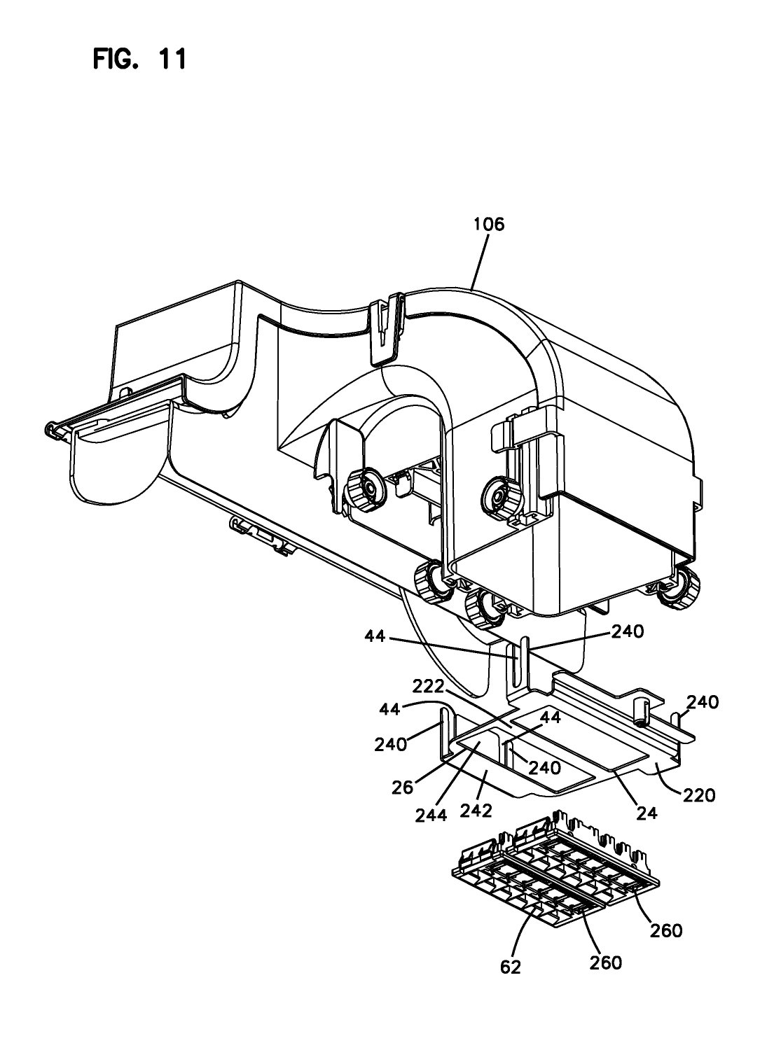

Referring now to FIGS. 10 and 11, an alternative cable termination apparatus 210 is shown. Cable termination apparatus 210 includes a frame 220 with a main body 222 having a plate shape with rear extensions 240 and a rear plate 244 extending directly from the plate portion 242. Modules 260 are in the form of RJ jack holders which snap fit into openings 24, 26.

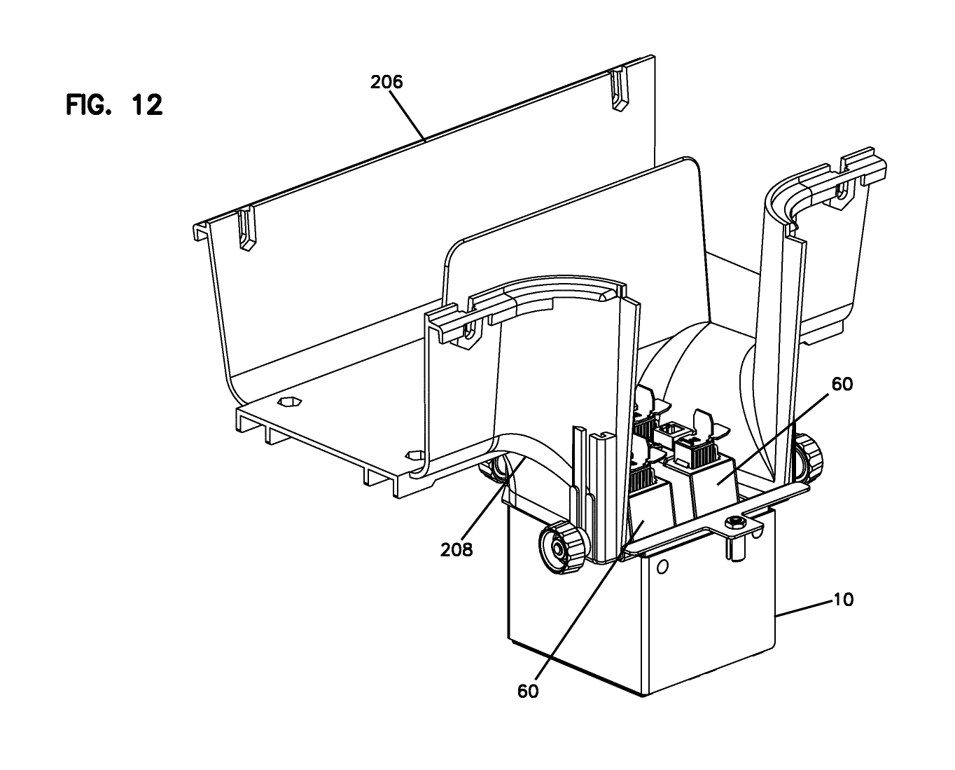

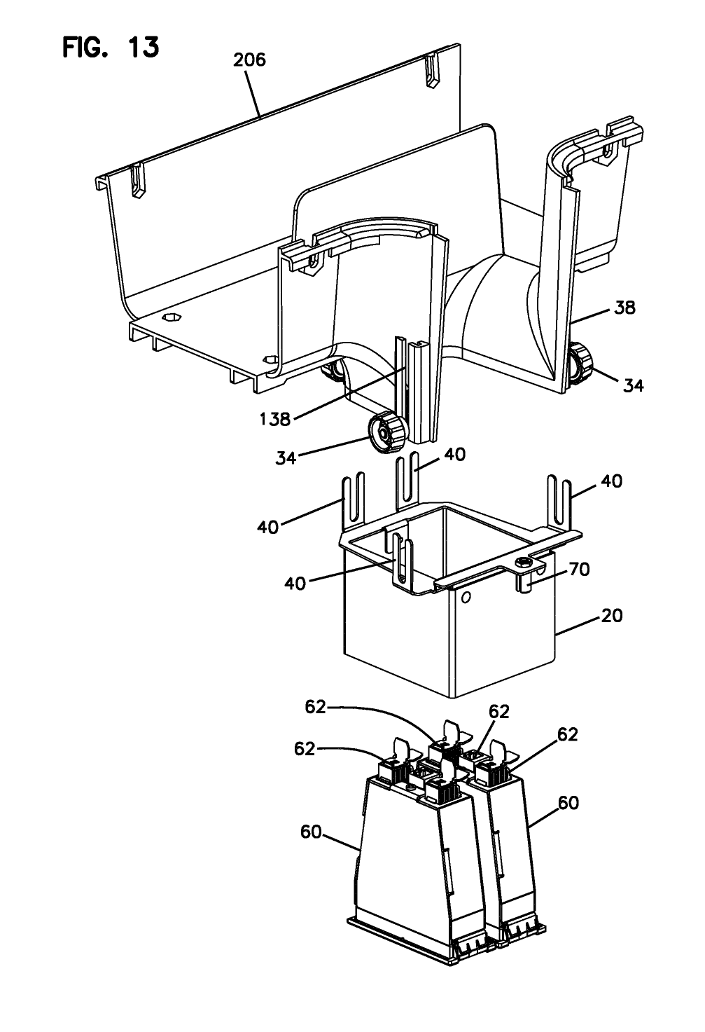

Referring now to FIGS. 12 and 13, cable termination apparatus 10 is shown mounted to an alternative lateral trough element 206 including a downspout portion 208.

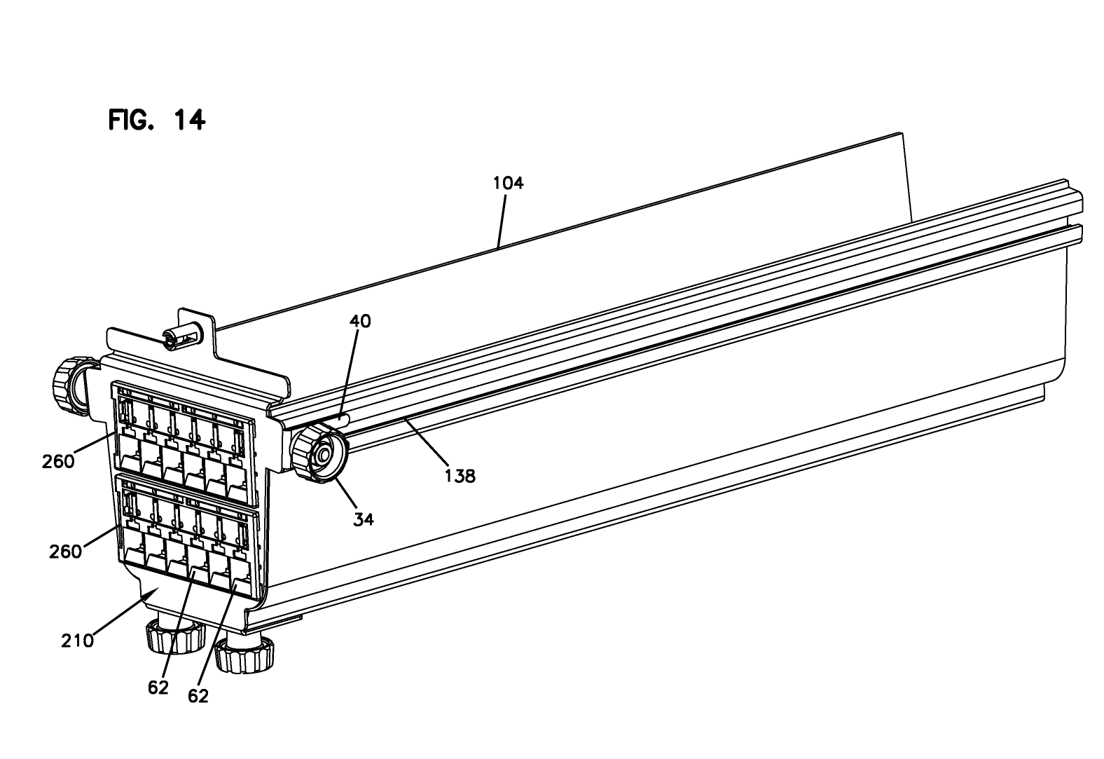

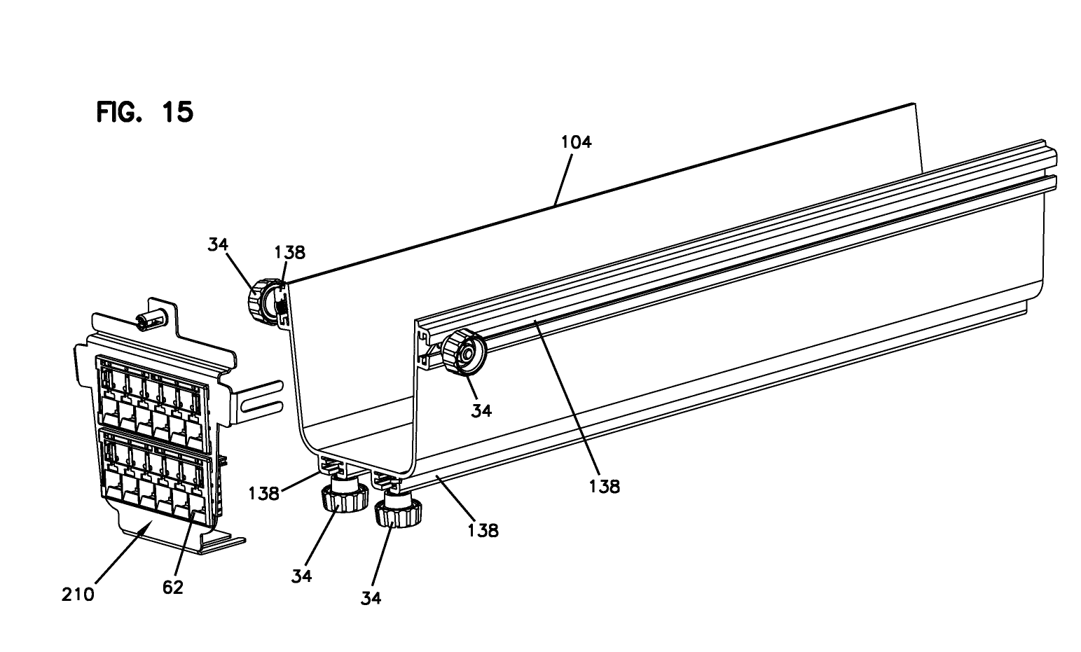

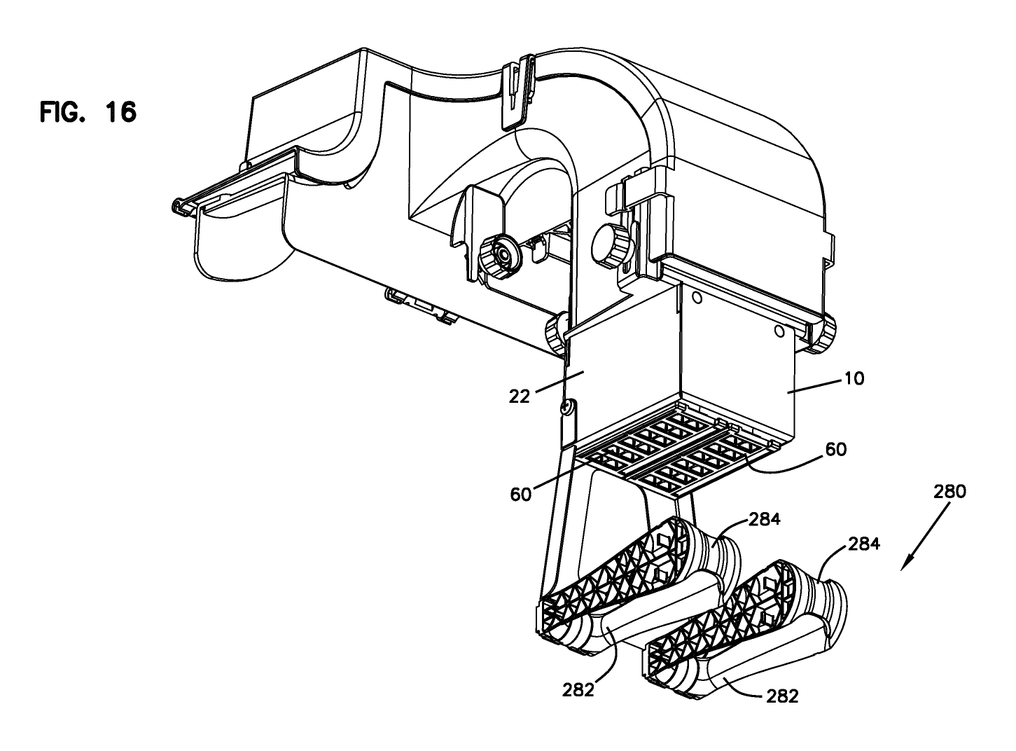

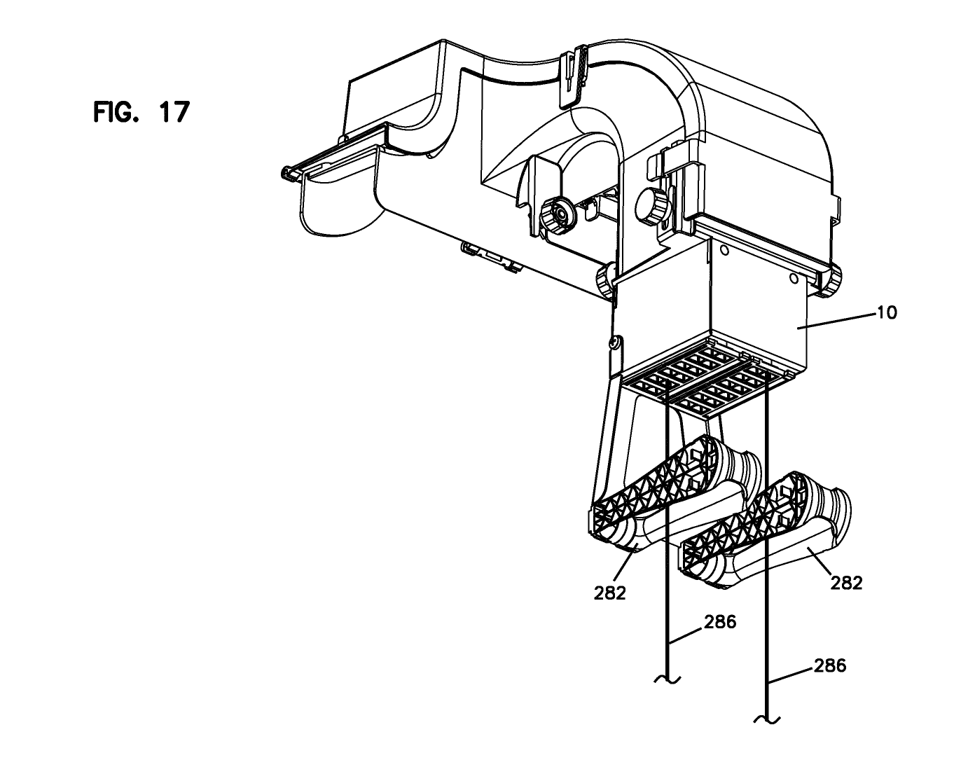

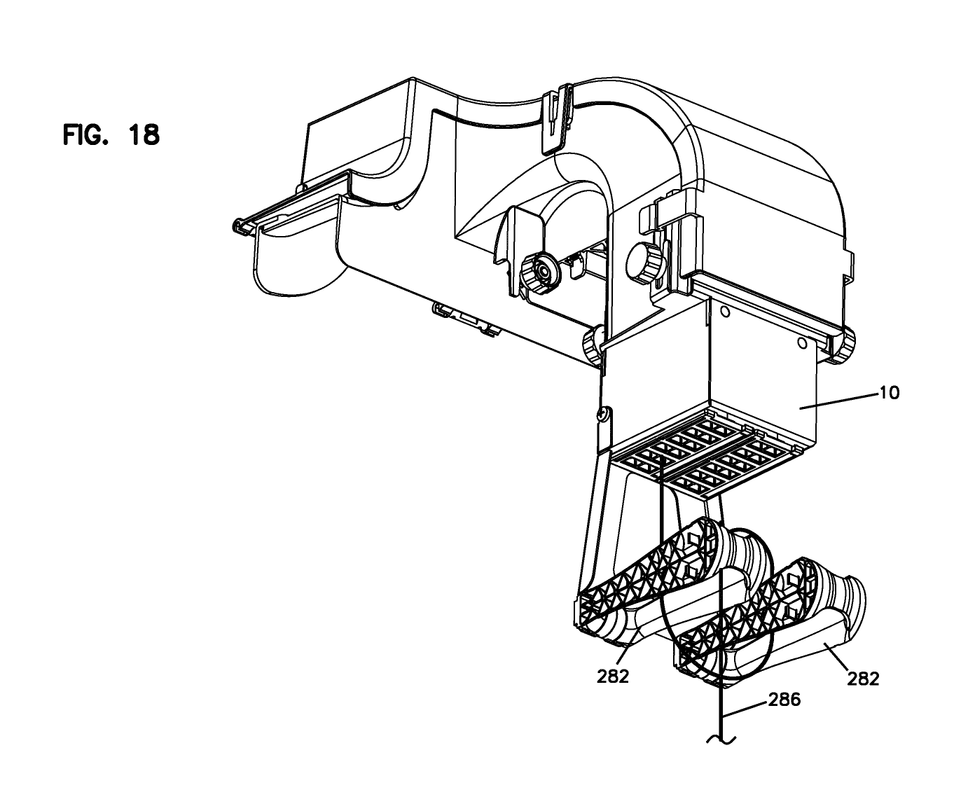

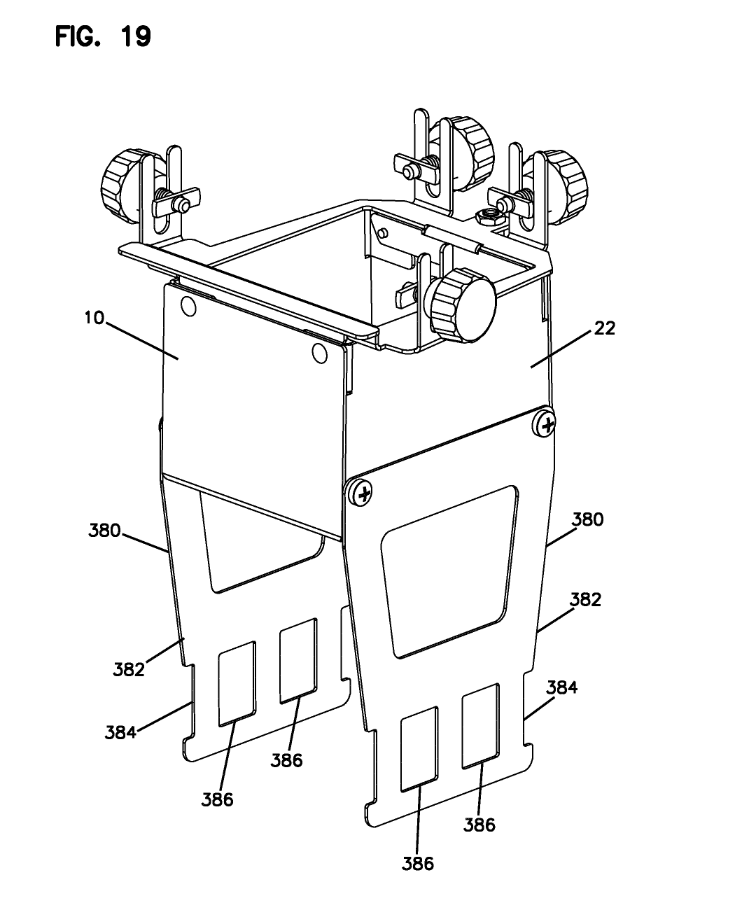

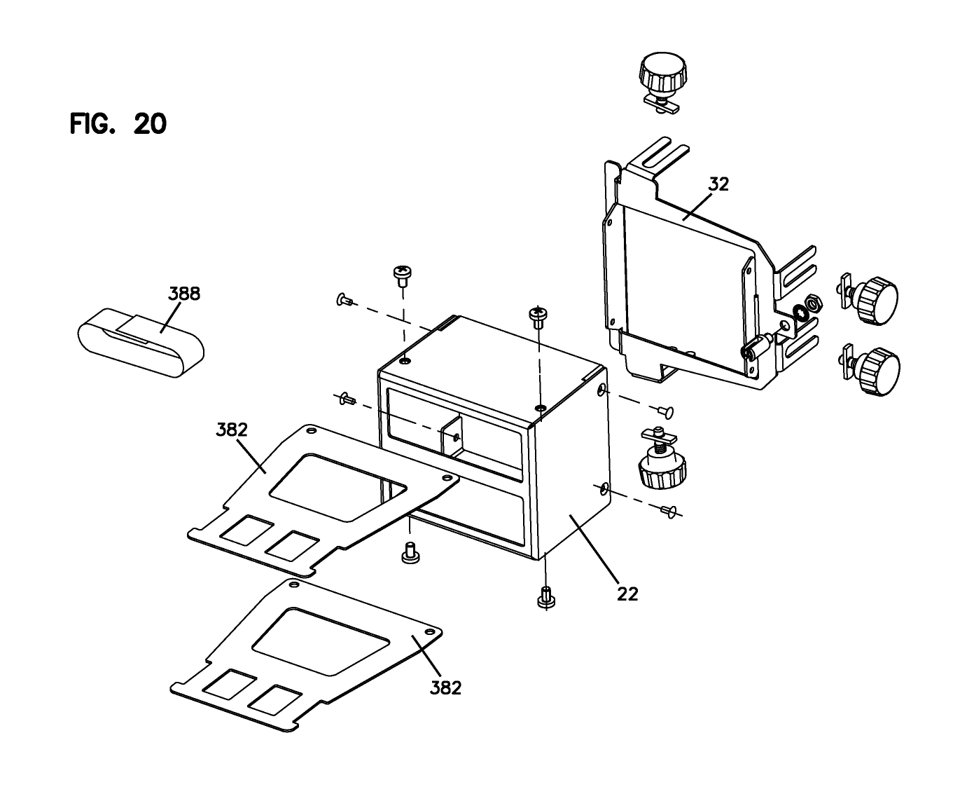

Referring now to FIGS. 14 and 15, cable termination apparatus 210 is shown mounted to an end of lateral trough 104.

The overhead pathway structures 120 of the present disclosure minimize the amount of rack space needed in a data center, central office, or other telecommunications facility. Alternatively, the devices allow for expansion and/or upgrade of systems and facilities having spatial constraints and can be added without having to add racks or cabinets. The devices are also easily incorporated and mounted to the various trough devices 104, 106, 206 shown with a quick connect coupling in the form of threaded fasteners 34. The present cable management system 100 does not increase costs by requiring replacement or upgrading of existing racks or existing overhead structures.

In addition, the present devices do not interfere with cooling pathways of existing systems. For example, in conventional methods, expanding the capacity of cabinets often requires the installation of additional termination panels within the cabinets. The added panels can block airflow needed to cool the electrical components inside the cabinet. Because the added panels or devices of the present system are mounted overhead, the panels or devices do not obstruct the airflow passages through the cabinet.

### Parts List

10 Cable termination apparatus
20 Frame
22 Main body
24 Opening
24 Opening
28 Side walls
32 Framework
34 Threaded fasteners
36 Winged retaining pieces
40 Extensions
42 Prongs
44 Slot
60 Module
62 Connection locations
64 Front
66 Back
70 Grounding lug
72 First body portion
74 Second body portion
100 Cable management system
104 Lateral trough
106 Exit trough
108 Main body
110 Flanges
112 Cover
114 Downspout portion
120 Overhead pathway cable structures
138 Slots
154 Racks
156 Cabinets
160 Cables
206 Alternative lateral trough element
208 Downspout portion
210 Cable termination apparatus
220 Frame
222 Main body
240 Extensions
242 Plate portion
244 Rear plate
260 Module

1. A telecommunications apparatus comprising:
a frame for mounting to a fiber optic cable trough, the frame including:
a main body defining an opening ;
a plurality of extensions extending transversely to the main body, each extension including a slot.

2. The apparatus of claim 1, further comprising a telecommunications module mounted to the main body within the opening.

3. The apparatus of claim 1, further comprising: a U-shaped fiber optic trough element, wherein the trough element includes external slots, and further comprising fasteners which mount the extensions to the slots, wherein the extensions extend parallel to the slots.

4. The apparatus of claim 1, wherein the frame includes a grounding lug.

5. The apparatus of claim 1, wherein the extension includes two parallel prongs separated by the slot.

6. The apparatus of claim 1, wherein the extensions are positioned on three sides of main body.

7. The apparatus of claim 1, wherein four extensions are provided.
